(19) United States
(12) Patent Application Publication
(10) Pub. No.: US 2005/0098099 A1
(43) Pub. Date: May 12, 2005

(54) Patterning apparatus and film patterning method

(75) Inventors: Kei Murayama, Nagano (JP); Mitsutoshi Higashi, Nagano (JP); Hideaki Sakaguchi, Nagano (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHINKO ELECTRIC INDUSTRIES CO. LTD., Nagano-shi (JP)

(21) Appl. No.: 11/011,051

(22) Filed: Dec. 15, 2004

Related U.S. Application Data
(62) Division of application No. 10/708,957, filed on Apr. 2, 2004.

(30) Foreign Application Priority Data
Apr. 21, 2003 (JP) 2003-115240

(51) Int. Cl. B05C 5/00; B05D 3/06

(52) U.S. Cl. 118/620; 118/642

(57) ABSTRACT

A patterning apparatus of the present invention includes a stage on which a substrate is loaded, a coating means for coating a liquid that reacts with an ultraviolet ray to deposit metal on the substrate, and an ultraviolet irradiating means for irradiating the ultraviolet ray onto the liquid that is coated on the substrate.

### BACKGROUND OF THE INVENTION

1. Field of the Invention

The present invention relates to a patterning apparatus and a film patterning method and, more particularly, a patterning apparatus for patterning a film by using an ink jet system and a film patterning method using the same.

2. Description of the Related Art

The patterning apparatuses using the ink jet system that forms a wiring pattern on a substrate by injecting a liquid from a nozzle are proposed nowadays. Because of use of the ink jet method, the wiring pattern can be formed in a very short time in contrast to the method using the plating, the photolithography, or the like.

In such patterning apparatus, the liquid prepared by dispersing metal particles such as Cu, Au, or the like into an alcohol-based solvent is used as such liquid. Then, the liquid is coated onto predetermined portions of the substrate by Spraying such liquid fed from the liquid supplying portion from the nozzle, and then the wiring pattern composed of the metal particles is formed by evaporating the solvent.

In paragraphs [0082] and [0141] of Patent Application Publication (KOKAI) 2001-210646 (Patent Literature 1), it is set forth that, upon forming a metal film on a circuit substrate, the spraying using the ink jet method may be employed in place of the employed of the plating, the photolithography, or the like.

However, in case the above liquid into which the metal particles are dispersed is used, the liquid solvent coated on the substrate evaporates and the metal particles still remain, nevertheless the metal particles are merely adhered onto the substrate to give small adhesion strength. Therefore, there exists such a problem that it is impossible to get the wiring pattern with high reliability.

Therefore, the technology to form the wiring pattern having firm adhesion to an underlying layer by using the ink jet method is desired earnestly.

In this case, in Patent Literature 1, no regard is paid to such a problem that the wiring pattern formed by using the ink jet method has small adhesion strength to the underlying layer.

### SUMMARY OF THE INVENTION

It is an object of the present invention to provide a patterning apparatus and a film patterning method, capable of forming stably a wiring pattern having firm adhesion to an underlying layer by means of an ink jet method.

The present invention is associated with a patterning apparatus that comprises a stage on which a substrate is loaded, a coating-means for coating a liquid that reacts with an ultraviolet ray to deposit metal on the substrate, and an ultraviolet irradiating means for irradiating the ultraviolet ray onto the liquid that is coated on the substrate.

In the patterning apparatus of the present invention, the substrate is loaded on the stage, and then the liquid containing the metal complex (gold complex, copper complex, or the like) is coated on the substrate by the coating means based on the ink jet system. Then, the ultraviolet ray (preferably, a wavelength is 100 to 300 nm) is irradiated by the ultraviolet irradiating means onto the liquid that is coated on the substrate. Accordingly, since metal ions in the liquid are reduced and the metal is deposited, the metal film pattern is formed.

In this manner, in the patterning apparatus of the present invention, since the metal ions in the liquid are deposited sequentially as the metal on the substrate by irradiating the ultraviolet ray, the metal film pattern is formed. Therefore, the metal film pattern can be formed to have firm adhesion strength to the substrate.

Also, since the metal film pattern is drawn directly by the ink jet method and formed, in contrast to the method of forming the metal film pattern by using the plating, the photolithography, or the like, a manufacturing apparatus can be simplified and manufacturing steps can be shortened. Therefore, a production cost can be reduced.

Also, the liquid should be coated only on the portion of the substrate, on which the metal film pattern is formed. Therefore, unlike the case that the photolithography, or the like is used, a production cost can be reduced in view of such a viewpoint that the metal film pattern can be formed without wasteful consumption of the material.

In addition, a quantity of the metal to be deposited in the liquid can be controlled by a radiation dose of the ultraviolet ray with no change of the type and the coating conditions of the liquid. Therefore, a film thickness of the metal film pattern can be adjusted without troublesome operations.

### BRIEF DESCRIPTION OF THE DRAWINGS

FIG. 1 is a schematic view showing a patterning apparatus of an embodiment of the present invention;

FIG. 2 and

FIG. 3 are a sectional view showing a coating means (bubble jet system) according to the patterning apparatus of the embodiment of the present invention respectively;

FIG. 4 and

FIG. 5 are a sectional view showing a coating means (piezo driving system) according to the patterning apparatus of the embodiment of the present invention respectively; and

FIGS. 6A to 6D are sectional views showing a film patterning method of the embodiment of the present invention in order.

### DETAILED DESCRIPTION OF THE PREFERRED EMBODIMENTS

Embodiments of the present invention will be explained with reference to the accompanying drawings hereinafter.

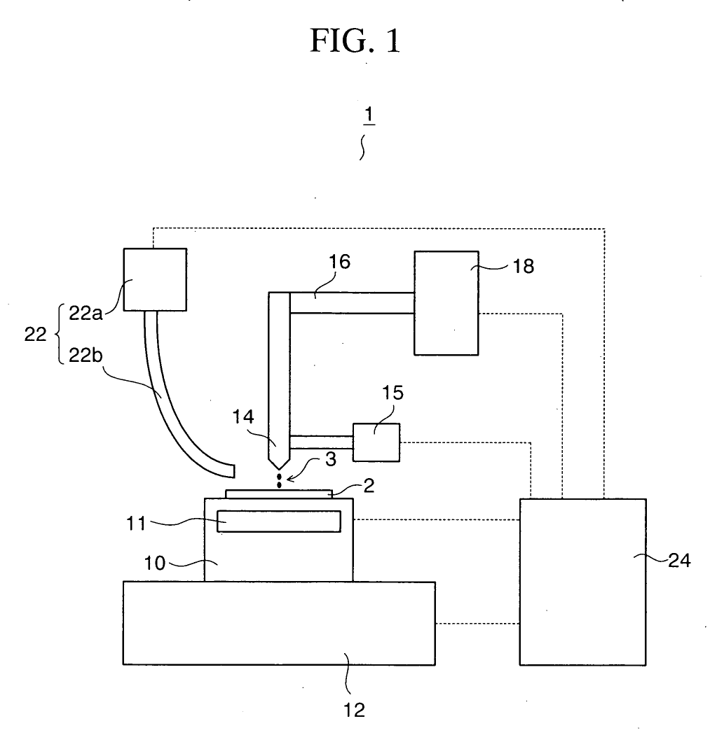

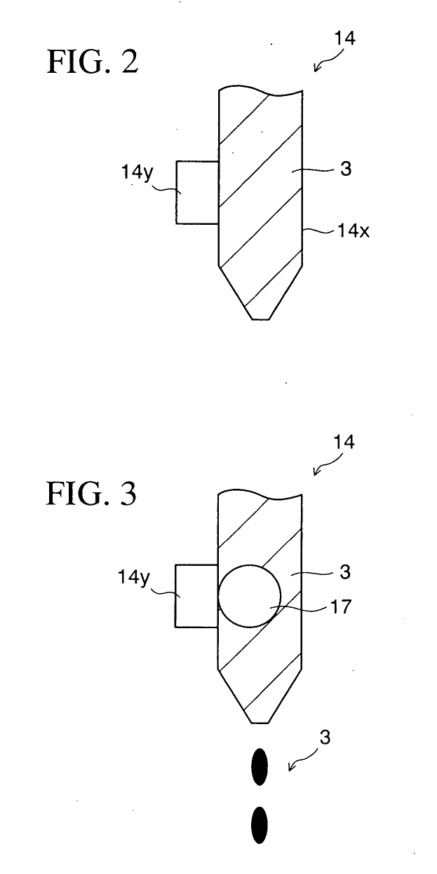

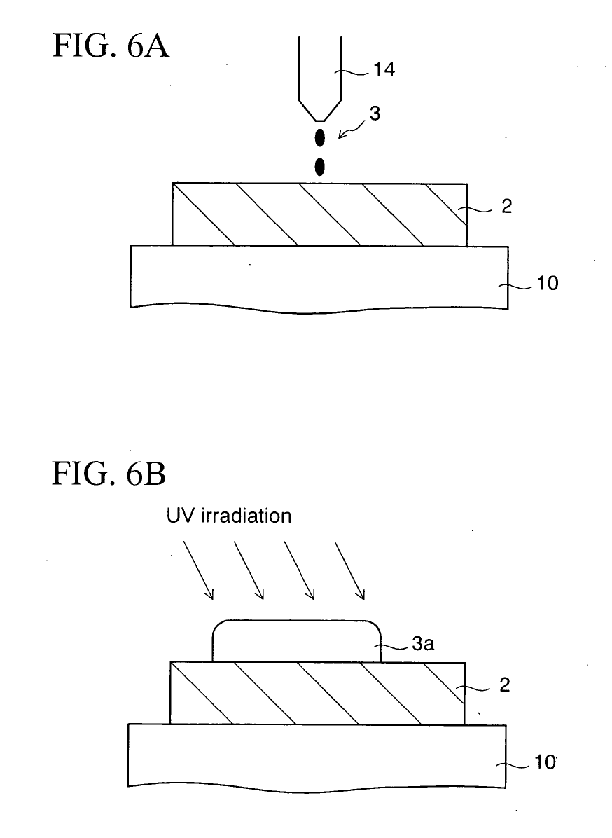

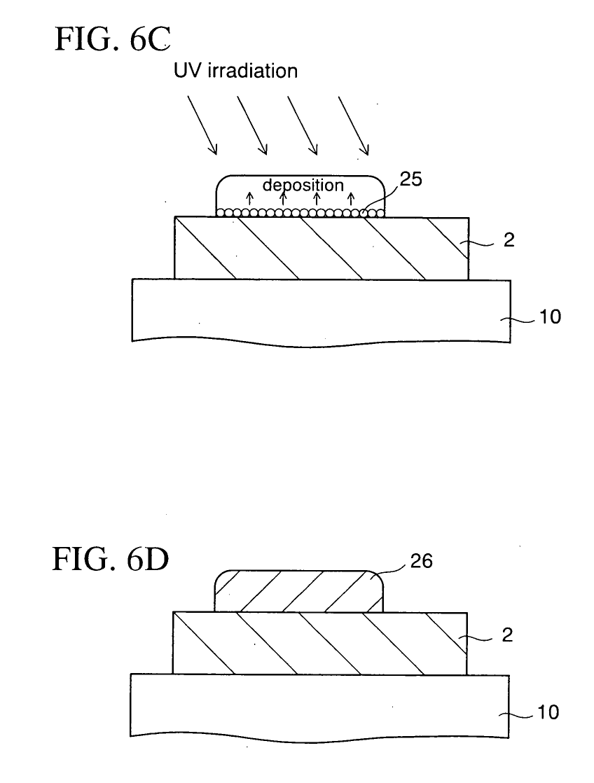

FIG. 1 is a schematic view showing a patterning apparatus of an embodiment of the present invention, FIG. 2 to FIG. 5 are sectional views showing a coating means according to the patterning apparatus of the embodiment of the present invention respectively, and FIGS. 6A to 6D are sectional views showing a film patterning method of the embodiment of the present invention in order.

As shown in FIG. 1, a patterning apparatus 1 of the present embodiment has a stage 10 on which a substrate 2 is loaded, and this stage 10 is connected to a stage moving means 12 that is used to move this stage. The stage moving means 12 is composed of a servo mechanism for moving the stage 10 to a predetermined position, and a servo motor for moving the servo mechanism. As a result, the stage 10 can be moved to any position in the horizontal direction including X-Y directions.

The substrate 2 is fixed onto the stage 10 by a chucking means (not shown) such as a vacuum chuck, or the like. Also, a heating means 11 such as a heater, or the like for heating the substrate 2 is provided to the stage 10 such that the substrate 2 can be heated up to 100 to 200° C., for example.

A coating means 14 of the ink jet system for spraying a liquid 3 from a nozzle onto the substrate 2 to coat the liquid thereon is positioned over the stage 10. The coating means 14 is connected to a liquid supplying portion 18 via a piping 16. Also, a nozzle controlling means 15 is connected to the coating means 14 to control the nozzle selection and the spraying characteristics of the coating means 14, and so forth.

In addition, a fiber 22b for irradiating the ultraviolet ray is arranged to extend to a neighborhood of the substrate 2. The fiber 22b is connected to a UV lamp 22a. The UV lamp 22a and the fiber 22b constitute an ultraviolet irradiating means 22. The UV lamp 22a emits the ultraviolet ray of a wavelength of 100 to 300 nm in such a manner that the ultraviolet ray can be irradiated onto the liquid 3 coated on the substrate 2 via the fiber 22b. Also, the UV lamp 22a can control a radiation intensity of the ultraviolet ray.

The liquid 3 according to the present embodiment is prepared by dissolving metal complexes in a solvent, and has such a characteristics that the metal is deposited onto the substrate 2 when the ultraviolet ray is irradiated. Detailed explanation of such liquid 3 will be given in the column of a film patterning method described later.

Further, the patterning apparatus 1 has a controller 24. This controller 24 is connected to the stage moving means 12, the heating means 11, the ultraviolet irradiating means 22, the liquid supplying portion 18, and the nozzle controlling means 15. Accordingly, positioning of the portion of the substrate 2 on which the liquid 3 is coated, spraying characteristic of the liquid 3 from the coating means 14, radiation dose and radiation timing of the ultraviolet ray, etc. are controlled by the controller 24.

As the structure of the above coating means 14, there are several types according to the system by which the liquid 3 is sprayed. In FIG. 2 and FIG. 3, the coating means 14 of a bubble jet system is exemplified. FIG. 2 shows such a state that the liquid 3 is filled in a nozzle 14x. As shown in FIG. 3, a bubble 17 is generated in the liquid 3 when a heating body 14y provided in the nozzle 14x is caused to generate heat, and then the liquid 3 is pushed out from a tip of the nozzle 14x by this bubble 17 and ejected to the outside.

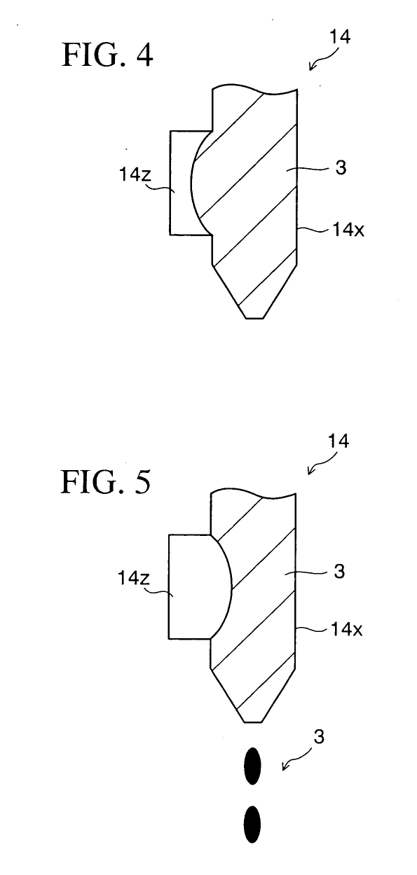

Also, in FIG. 4 and FIG. 5, the coating means 14 of a piezo driving system is exemplified. As shown in FIG. 4, a piezoelectric transducer element (piezo element) 14z for generating a strain based on a piezoresistance effect is provided to the nozzle 14x. When a voltage is applied to the piezoelectric transducer element 14z, the piezoelectric transducer element 14z becomes hollow, so that the liquid 3 is injected into the nozzle 14x. Then, as shown in FIG. 5, when the voltage applied to the piezoelectric transducer element 14z is changed, conversely the piezoelectric transducer element 14z becomes inflated, so that the liquid 3 is pushed out from the tip of the nozzle 14x and ejected to the outside.

Alternately, the liquid 3 may be ejected from the nozzle 14x by an operation of an ultrasonic vibrator provided to the nozzle 14x.

An aperture size and the number of the nozzle 14x of the coating means 14 are not particularly limited. For example, in case a wiring pattern of a wiring substrate is formed, an aperture of the tip of the nozzle 14x is set to 30 to 80 μm (preferably, almost 50 μm), and the number of the nozzle 14x is set to 30 to 90 (preferably, almost 60). As a result, even if width, film thickness, or total area, etc. of a metal film pattern is changed, the patterning apparatus 1 can cope easily with such changes. Also, the nozzle controlling means 15 can not only select the nozzle 14x from which the liquid 3 is ejected but also control an ejecting amount, an ejecting timing, etc. of the liquid 3.

The patterning apparatus 1 of the present embodiment has such a configuration. While moving the stage 10 on which the substrate 2 is loaded in the horizontal direction by the stage moving means 12, the liquid 3 can be ejected by the coating means 14 and coated onto any portion on the substrate 2. Then, while coating the liquid 3 on the substrate 2 or after the liquid 3 is coated on the substrate 2, the ultraviolet ray can be irradiated onto the liquid 3 on the substrate 2 by the ultraviolet irradiating means 22. Accordingly, as described later, because metal ions in the liquid 3 are reduced and deposited on the substrate 2 as the metal, the metal film pattern having the firm adhesion strength is formed on the substrate 2.

Next, a film patterning method using the above patterning apparatus 1 will be explained hereunder. First, the substrate 2 is loaded on the stage 10 of the foregoing patterning apparatus 1, and then such substrate 2 is fixed by the chucking means. At this time, the heating means 11 in the stage 10 is turned on so as to keep a temperature of the substrate 2 at 100 to 200° C.

Then, as shown in FIGS. 6A and 6B, while moving the stage 10 in the horizontal direction or in a state that the stage 10 is being fixed, a liquid coating layer 3a is formed by coating the liquid 3 on the portion of substrate 2, on which the metal film pattern is formed, by means of the coating means 14. Then, the ultraviolet ray emitted from the UV lamp 22a are irradiated onto the liquid coating layer 3a on the substrate 2 from the tip of the fiber 22b. At this time, the ultraviolet ray may be irradiated at any time onto the liquid coating layer 3a on the substrate 2 while coating the liquid 3. A lamp having a wavelength of almost 300 nm or less is used as the UV lamp 22a, and preferably an excimer UV lamp having a wavelength of 172 nm is used.

As the liquid 3 used in the present embodiment, a liquid prepared by dissolving KAu(CN)₂ (gold complex) as an example of the metal complex into the solvent is used. Otherwise, as the metal complex, copper (Cu) complex, palladium (Pd) complex, nickel (Ni) complex, or the like may be used. As the copper complex, there are Cu-EDTA (ethylenediamine 4 acetate), etc. Also, as the palladium complex, there are ultraviolet-sensitive compound (palladium alloy), palladium organic complex (Pd-EDTA, Pd-amine complex, Pd-PVA (poly vinyl alcohol)), Pd-chelate compound, palladium dithiooxalate, palladium carboxylate), etc.

As the solvent in which these metal complexes are dissolved, water, KOH aqueous solution, mixed solution consisting of water and ethanol (used to control a surface tension), or the like is used.

For example, when the ultraviolet ray is irradiated onto the liquid coating layer 3a that is formed by coating the liquid 3, in which KAu(CN)₂ is dissolved, on the substrate 2, first the oxygen in the air receives an energy (h ν) of the ultraviolet ray to generate ozone (O₃), as shown in Formula (1). Then, as shown in Formula (2), the O₃ reacts with CN⁻ ions in the liquid coating layer 3a to generate CNO⁻ and O₂. Then, as shown in Formula (3), CNO₋ reacts with O₃ and H₂O and they are decomposed into HCO₃⁻, nitrogen (N₂), and oxygen (O₂). In this case, the CN⁻ ions are decomposed directly by the ultraviolet ray.
3O₂+hν→2O₃ Formula (1)
CN⁻+O₃→CNO⁻+O₂ Formula (2)
2CNO⁻+3O₃+H₂O→2HCO₃⁻+N₂+3O₂ Formula (3)
In this manner, when the ultraviolet ray is irradiated onto the liquid coating layer 3a, the CN⁻ ions in the liquid coating layer 3a are decomposed by the oxidizing reaction.

At this time, Au(CN)₂⁻ ions in the liquid coating layer 3a are also decomposed. Therefore, as shown in FIG. 6C, Au 25 is deposited sequentially on the substrate 2. Also, at this time, since the substrate 2 is heated at about 100 to 200° C., not only the above reaction can be accelerated but also the solvent in the liquid coating layer 3a is evaporated after the Au deposition is ended.

Accordingly, as shown in FIG. 6D, a metal film pattern 26 made of the deposited gold 25 is formed.

By using the foregoing liquid in which various metal complexes from which the metal is deposited to react with the ultraviolet ray, are dissolved, various metal film patterns (Cu film, Pd film, Ni film, or the like) can be formed in addition to the gold film. In case the liquid in which the Pd complex is dissolved is used, such liquid is effective for the formation of Pd nucleus as the catalyst of the electroless plating.

At this time, a quantity of the gold 25 to be deposited can be controlled by adjusting a dose of the ultraviolet ray irradiated onto the liquid coating layer 3a. Therefore, a film thickness of the metal film pattern 26 can be readily adjusted without changes of the specification and coating conditions of the liquid 3.

In this manner, since the ultraviolet ray is irradiated onto the liquid coating layer 3a in which the metal complex is dissolved, the metal is deposited sequentially on the substrate 2 to form the metal film pattern 26. Therefore, the metal film pattern 26 can be formed on the substrate 2 to have the firm adhesion strength. Also, as compared with the method in which the metal film pattern is formed by using the plating, the photolithography, or the like, a manufacturing apparatus can be simplified and manufacturing steps can be shortened. Therefore, a production cost can be reduced.

Also, the liquid 3 should be coated only on the portion of the substrate 2, on which the metal film pattern 26 is formed. Therefore, unlike the case of the photolithography, or the like, a production cost can be reduced in light of such a viewpoint that the metal film pattern 26 can be formed without wasteful consumption of the material.

In this case, in the patterning apparatus of the ink jet system in the related art, the metal film pattern is formed by evaporating the liquid solvent, in which the metal particles are dispersed, to leave the metal particles on the substrate. Therefore, when the film thickness of the metal film pattern is changed, the type (content of the metal particles, etc.) and the coating conditions of the liquid must be changed respectively and thus the operations become troublesome.

However, in the present embodiment, a quantity of deposition of the metal contained in the liquid coating layer 3a can be controlled by the radiation dose of the ultraviolet ray without change of the type and the coating conditions of the liquid 3. Therefore, the film thickness of the metal film pattern 26 can be adjusted without troublesome operations, and also a work efficiency can be improved.

1. A patterning apparatus comprising:
a stage on which a substrate is loaded;
a coating means for coating a liquid, which reacts with an ultraviolet ray to deposit metal, on the substrate; and
an ultraviolet irradiating means for irradiating the ultraviolet ray onto the liquid that is coated on the substrate.

2. A patterning apparatus according to claim 1, wherein the liquid is a liquid in which a metal complex is dissolved in a solvent.

3. A patterning apparatus according to claim 1, wherein the coating means coats the liquid by ejecting the liquid by means of a bubble jet system.

4. A patterning apparatus according to claim 1, wherein the coating means coats the liquid by ejecting the liquid by means of a piezo driving system utilizing a piezoresistance effect.

5. A patterning apparatus according to claim 1, wherein a heating means for heating the substrate is provided to the stage.

6. A patterning apparatus according to claim 1, wherein a wavelength of the ultraviolet ray is 100 to 300 nm.
